(19) United States
(12) Patent Application Publication
(10) Pub. No.: US 2015/0160502 A1
(43) Pub. Date: Jun. 11, 2015

(54) LCD DEVICE

(71) Applicant: Shenzhen China Star Optoelectronics Technology Co. Ltd., Shenzhen (CN)

(72) Inventors: Shih Hsiang Chen, Shenzhen (CN); Gang Yu, Shenzhen (CN); Ruilian Yang, Shenzhen (CN)

(21) Appl. No.: 13/703,365

(22) PCT Filed: Sep. 6, 2012
(86) PCT No.: PCT/CN12/81042

§ 371 Date: Dec. 11, 2012

(30) Foreign Application Priority Data
Aug. 21, 2012 (CN) 201210299235.6

(51) Int. Cl. G02F 1/1333

(52) U.S. Cl. CPC G02F 1/133308; G02F 2001/133314

(57) ABSTRACT

The present invention discloses an LCD device, which includes a display panel, a frame, and a fastener. The frame is disposed on a surface of the display panel. The fastener is disposed between the frame and the display panel. The fastener includes a male button and a female button. The male button is fixed on the surface of the display panel facing the frame, and the female button is disposed on a surface of the frame facing the display panel. The male button and the female button are fitted together so that the display panel is fixed on the frame, whereby the LCD device without a bezel can be realized.

### FIELD OF THE INVENTION

The present invention relates to a display device, and more particularly to a liquid crystal display (LCD) device without a bezel.

### BACKGROUND OF THE INVENTION

An LCD device has the advantages of low power consumption, low radiation, and so on; therefore, it is widely used in display devices nowadays. With the continuous advancement of LCD technology, the LCD device with a large size and a thin profile increasingly becomes a mainstream in market demand, so the LCD follows a current trend toward a narrow bezel.

However, assembly structures of the typical LCD device generally includes a front bezel, a display panel, a backlight module, and back cover. The front bezel and the back cover are utilized to sandwich the display panel and the backlight module therebetween and to fix them. In the assembling process, the front bezel and the back cover need to be engage with each other; thus, the front bezel and the back cover have corresponding coupling mechanism that are respectively disposed thereon. In general, said coupling mechanism is screw holes and screw nuts. However, whatever the coupling mechanism, certain area of the front bezel will be occupied, such that the front bezel is difficult to be designed as a narrower structure. Therefore, the demands for the narrow bezel even no bezel can not be realized.

### SUMMARY OF THE INVENTION

An objective of the present invention is to provide an LCD device, which can abandon the design of the front bezel to realize the LCD device without the bezel or with the bezel only at one side.

To achieve the foregoing objective, the present invention provides an LCD device, which includes a display panel, a frame, and a fastener. The frame is disposed on a surface of the display panel. The fastener is disposed between the frame and the display panel. The fastener includes a male button and a female button. The male button is fixed on the surface of the display panel facing the frame, and the female button is disposed on a surface of the frame facing the display panel. The male button and the female button are fitted together so that the display panel is fixed on the frame.

In the LCD device of the preferred embodiment, the male button has a neck portion and a ringlike engaged portion; the female button has a fastening hole matching the male button. The fastening hole consists of a big hole and a small hole connected to the big hole. The ringlike engaged portion can enter the fastening hole via the big hole and move towards the small hole so that the neck portion is limited within the small hole. Specifically, the small hole is slightly larger than the neck portion of the male button and smaller than the ringlike engaged portion.

Preferably, the male button is fixed on the surface of the display panel by glue.

In an LCD device of another preferred embodiment, the LCD device includes a display panel, a frame, fasteners and an L-shaped component. The display panel has four sides. The frame is disposed on a surface of the display panel. The fasteners are disposed between the frame and the display panel, and positioned at three sides among the four sides of the display panel. Each of the fasteners includes a male button and a female button. The male button is fixed on the surface of the display panel facing the frame; the female button is disposed on a surface of the frame facing the display panel, wherein the male button and female button are fitted together. The L-shaped component is disposed on one side without the fasteners among the four sides of the display panel, and utilized to abut against the frame and the side without the fasteners among the four sides of the display panel.

In the LCD device of the preferred embodiment, the male button has a neck portion and a ringlike engaged portion. The female button has a fastening hole matching the male button. The fastening hole consists of a big hole and a small hole connected to the big hole. The ringlike engaged portion can enter the fastening hole via the big hole and move towards the small hole so that the neck portion is limited within the small hole. More specifically, the small hole is slightly larger than the neck portion of the male button and smaller than the ringlike engaged portion.

In the LCD device of the preferred embodiment, the three sides of the display panel on which the fasteners are disposed are a left side, a right side, and a top side; the L-shaped component is disposed on a bottom side of the display panel. In addition, the small hole is positioned at an upper side of the big hole in the female button of each of the fasteners. More specifically, the L-shaped component abuts against the bottom side of the display panel upwards, so that the neck portion of each male button is fixed within the small hole of each fastening hole

In comparison with the prior art, the display panel can be fixed on the frame through the embedment of the male button and the female button, so the display panel dose not need to be fixed by the front bezel from the outside of the display panel. As a result, the objective of the present invention for the LCD device without bezel can be realized. In addition, the display panel also can be fixed in the directions of X-axis and Z-axis by the fasteners on the left, right, and top sides of the display panel, and then the display panel is fixed in the directions of Y-axis by the L-shaped component abutting the display panel upwards, thereby constructing the LCD device with the bezel only at the bottom side.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a perspective view schematically illustrating a display panel of an LCD device according to one preferred embodiment of the present invention;

FIG. 2 is a top view schematically illustrating a frame of the LCD device according to the preferred embodiment of the present invention;

FIG. 3 is an enlarged perspective view illustrating the male button of the embodiment;

FIG. 4 is an enlarged top view illustrating the female button of the embodiment;

FIG. 5 is a perspective view schematically illustrating a display panel of an LCD device according to another preferred embodiment of the present invention;

FIG. 6 is a top view schematically illustrating a frame of the LCD device according to another preferred embodiment of the present invention;

FIG. 7 is a perspective view schematically illustrating the LCD device after assembling according to another preferred embodiment of the present invention;

FIG. 8 is an enlarged top view illustrating the female button of another preferred embodiment; and

FIG. 9 is a schematic cross-sectional diagram along A-A′ in FIG. 7.

### DETAILED DESCRIPTION OF THE PREFERRED EMBODIMENTS

Descriptions of the following embodiments refer to attached drawings which are utilized to exemplify specific embodiments. In different drawings, the same reference numbers will be used throughout the drawings to refer to the same or like parts.

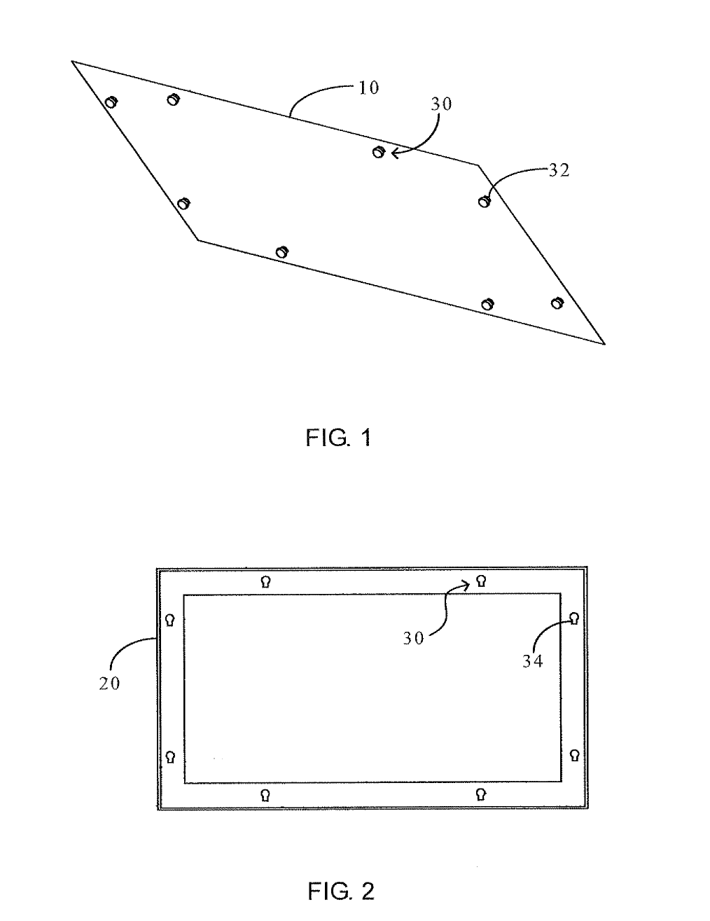

Referring to FIG. 1 and FIG. 2, FIG. 1 is a perspective view schematically illustrating a display panel of an LCD device according to one preferred embodiment of the present invention, and FIG. 2 is a top view schematically illustrating a frame of the LCD device according to the preferred embodiment of the present invention. The LCD device of the preferred embodiment includes a display panel 10, a frame 20, and a plurality of fasteners 30. However, the LCD device of the preferred embodiment further includes a back cover, a backlight module, a driver chip, and so on (not shown), all of which are well-known; no further detail will be provided herein.

the frame 20, otherwise known as mold frame, is disposed on a surface of the display panel 10. That is to say, the frame 20 is disposed between the display panel 10 and the back cover, and the frame 20 is preferably fixed on the back cover.

The fastener 30 is disposed between the frame 20 and the display panel 10. Specifically, the fasteners 30 includes male buttons 32 (FIG. 1) and female buttons 34 (FIG. 2). The male buttons 32 are fixed on the surface of the display panel 10 facing the frame 20. Specifically, the display panel 10 includes an upper substrate, a lower substrate, and a liquid crystal layer (not shown) between the upper substrate and the lower substrate. The male buttons 32 are stuck on an outer surface of the lower substrate. It is worth mentioning that a polarizer is disposed on the outer surfaces of the upper substrate and the lower substrate, that is, the male button 32 is fixed on the polarizer of the lower substrate. Preferably, the male buttons are fixed on the surface of the display panel 10 by glue. However, the fixing manner for the male button 32 and the display panel 10 is not limited to be implemented by glue in the present invention.

As shown in FIG. 2, the female button 34 is disposed on a surface of the frame 20 facing the display panel 10. The display panel 10 is fixed on the frame 20 through the embedment of the male button and the female button; therefore, the display panel 10 dose not need to be fixed by the front bezel from the outside of the display panel 10.

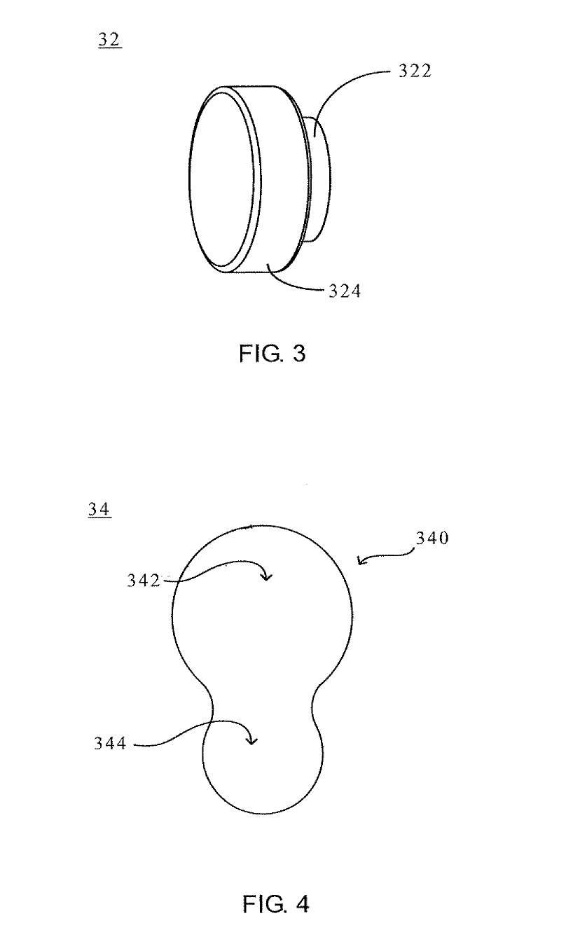

Specific structures of the male button 32 and female button 34 in the preferred embodiment of the present invention will be explained in detail in the following description. Referring to FIG. 3 and FIG. 4, FIG. 3 is an enlarged perspective view illustrating the male button 32 of the embodiment; FIG. 4 is an enlarged top view illustrating the female button 34 of the embodiment. The male button 32 has a neck portion 322 and a ringlike engaged portion 324. One end of the neck portion 322 is fixed on the display panel 10, and another end of the neck portion 322 is coupled to the ringlike engaged portion 324.

As shown in FIG. 4, the female button 34 has a fastening hole 340 matching the male button 32. The fastening hole 340 consists of a big hole 342 and a small hole 344 connected to the big hole 342. In assembling the display panel 10 and the frame 20 together, the ringlike engaged portion 324 of the male button 32 can enter the fastening hole 340 via the big hole 342 and move towards the small hole 344 so that the neck portion 322 is limited within the small hole 344. It should be noted that the small hole 344 is slightly larger than the neck portion 322 of the male button 32 and smaller than the ringlike engaged portion 324. In addition, the connection between the big hole 342 and the small hole 344 is designed to let the neck portion 322 pass through. When the display panel 10 and the frame 20 are set upright, the male buttons 32 on the display panel 10 can fixed in the fastening holes 340 of the frame 20 due to an action of gravitation, so the front bezel is not required to be set, thereby achieve the objective of no bezel.

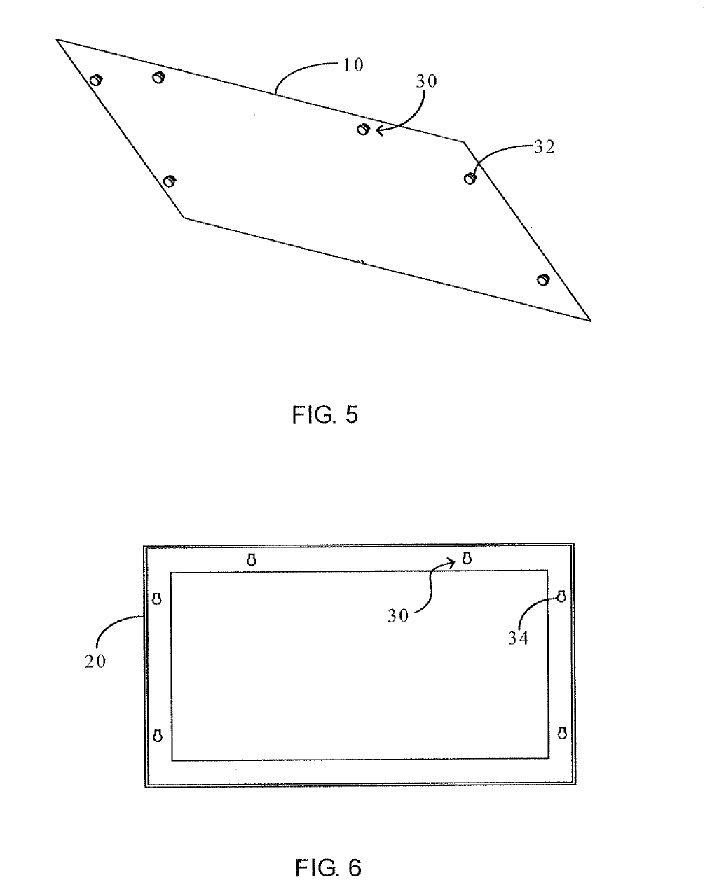

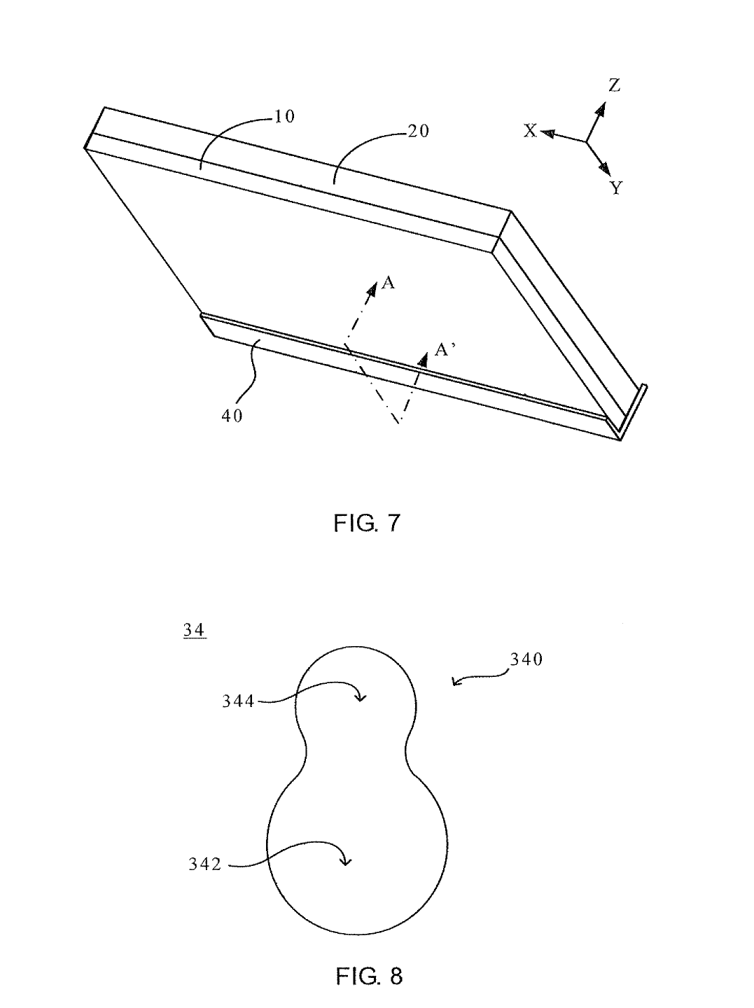

An LCD device of another preferred embodiment of the present invention will be explained in the following description. Referring to FIG. 5, FIG. 6 and FIG. 7, FIG. 5 is a perspective view schematically illustrating a display panel of an LCD device according to another preferred embodiment of the present invention; FIG. 6 is a top view schematically illustrating a frame of the LCD device according to another preferred embodiment of the present invention; and FIG. 7 is a perspective view schematically illustrating the LCD device after assembling according to another preferred embodiment of the present invention. The LCD device of the preferred embodiment includes a display panel 10, a frame 20, a plurality of fasteners 30, and an L-shaped component 40. Similarly, the LCD device of the preferred embodiment further includes a back cover, a backlight module, a driver chip, and so on (not shown), all of which are well-known; no further detail will be provided herein. As shown in FIG. 5, the display panel 10 has four sides, that is, top, bottom, left, and right sides.

The frame 20 is disposed on a surface of the display panel 10. That is to say, the frame 20 is disposed between the display panel 10 and the back cover, and the frame 20 is preferably fixed on the back cover.

The fasteners 30 are disposed between the frame 20 and the display panel 10, and positioned at three sides among the four sides of the display panel 10. In the embodiment, the three sides of the display panel 10 on which the fasteners 30 are disposed are the left, right, and top sides. Similarly, each fasteners 30 includes a male buttons 32 (FIG. 5) and a female buttons 34 (FIG. 6). The male buttons 32 are fixed on the surface of the display panel 10 facing the frame 20. Specifically, the display panel 10 includes an upper substrate, a lower substrate, and a liquid crystal layer (not shown) between the upper substrate and the lower substrate. The male buttons 32 are stuck on an outer surface of the lower substrate. It is worth mentioning that a polarizer is disposed on the outer surfaces of the upper substrate and the lower substrate, that is, the male button 32 is fixed on the polarizer of the lower substrate. Preferably, the male buttons are fixed on the surface of the display panel 10 by glue. However, the fixing manner for the male button 32 and the display panel 10 is not limited to be implemented by glue in the present invention.

As shown in FIG. 6, the female button 34 is disposed on a surface of the frame 20 facing the display panel 10. The male button 32 and the female button 34 are fitted together. Specific structures of the male button 32 and female button 34 in the preferred embodiment of the present invention will be explained in detail in the following description. Referring to FIG. 3 again, the male button 32 also has a neck portion 322 and a ringlike engaged portion 324 as the above-mentioned embodiment. One end of the neck portion 322 is fixed on the display panel 10, and another end of the neck portion 322 is coupled to the ringlike engaged portion 324.

Referring to FIG. 8, FIG. 8 is an enlarged top view illustrating the female button 34 of another preferred embodiment. The female button 34 has a fastening hole 340 matching the male button 32. The fastening hole 340 consists of a big hole 342 and a small hole 344 connected to the big hole 342. In assembling the display panel 10 and the frame 20 together, the ringlike engaged portion 324 of the male button 32 can enter the fastening hole 340 via the big hole 342 and move towards the small hole 344 so that the neck portion 322 is limited within the small hole 344. It should be noted that the small hole 344 is slightly larger than the neck portion 322 of the male button 32 and smaller than the ringlike engaged portion 324. In addition, the connection between the big hole 342 and the small hole 344 is designed to let the neck portion 322 pass through. One difference from the above-mentioned embodiment is that the small hole 344 is positioned at an upper side of the big hole 342 in the female button 34 of each of the fasteners 30.

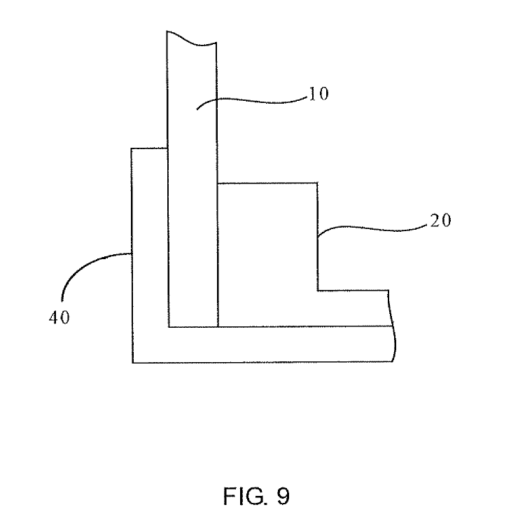

Referring to FIG. 7 and FIG. 9, FIG. 9 is a schematic cross-sectional diagram along A-A′ in FIG. 7. One difference from the above-mentioned embodiment is that the LCD device of the embodiment further has the L-shaped component 40. The L-shaped component 40 is disposed on the side without the fasteners 30 among the four sides of the display panel 10, and utilized to abut against the frame 20 and the side without the fasteners 30 among the four sides of the display panel 10. As shown in FIG. 9, the L-shaped component 40 is disposed on the bottom side of the display panel 10, and utilized to abut against the frame 20 and the bottom side of the display panel 10. More specifically, in assembling the display panel 10 and the frame 20, the L-shaped component 40 abuts against the bottom side of the display panel 10 upwards, so that the neck portion 322 of each male button 32 has an upward position limit at the small hole 344 of each fastening hole 340, thereby fixing both the display panel 10 and the frame 20.

In summary, the display panel 10 can be fixed on the frame 20 through the embedment of the male button 32 and the female button 34, so the display panel 10 dose not need to be fixed by the front bezel from the outside of the display panel 10. As a result, the objective of the present invention for the LCD device without bezel can be realized. Moreover, the display panel 10 also can be fixed in the directions of X-axis and Z-axis by the fasteners 30 on the left, right, and top sides of the display panel 10, and then the display panel 10 is fixed in the directions of Y-axis by the L-shaped component 40 abutting the display panel 10 upwards, thereby constructing the LCD device 10 with the bezel only at the bottom side.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal display (LCD) device, comprising:
a display panel having four sides;
a frame disposed on a surface of the display panel;
a plurality of fasteners disposed between the frame and the display panel, and positioned at left, right and top sides among the four sides of the display panel, each of the fasteners comprising a male button and a female button, the male button fixed on the surface of the display panel facing the frame, the female button disposed on a surface of the frame facing the display panel, wherein the male button and female button are fitted together; and
an L-shaped component disposed on a bottom side among the four sides of the display panel, and utilized to abut against the frame and the bottom side of the display panel, so that the display panel is fixed on the frame.

2. The LCD device according to claim 1, wherein the male button has a neck portion and a ringlike engaged portion; the female button has a fastening hole matching the male button, the fastening hole consisting of a big hole and a small hole connected to the big hole, wherein the ringlike engaged portion can enter the fastening hole via the big hole and move towards the small hole so that the neck portion is limited within the small hole.

3. The LCD device according to claim 2, wherein the small hole is slightly larger than the neck portion of the male button and smaller than the ringlike engaged portion.

4. The LCD device according to claim 2, wherein the small hole is positioned at an upper side of the big hole in the female button of each of the fasteners.

5. The LCD device according to claim 4, wherein the neck portion of each male button is fixed within the small hole of each fastening hole.

6. An LCD device, comprising:
a display panel;
a frame disposed on a surface of the display panel; and
a fastener disposed between the frame and the display panel, the fastener comprising a male button and a female button, the male button fixed on the surface of the display panel facing the frame, the female button disposed on a surface of the frame facing the display panel, wherein the male button and the female button are fitted together so that the display panel is fixed on the frame.

7. The LCD device according to claim 6, wherein the male button has a neck portion and a ringlike engaged portion; the female button has a fastening hole matching the male button, the fastening hole consisting of a big hole and a small hole connected to the big hole, wherein the ringlike engaged portion can enter the fastening hole via the big hole and move towards the small hole so that the neck portion is limited within the small hole.

8. The LCD device according to claim 7, wherein the small hole is slightly larger than the neck portion of the male button and smaller than the ringlike engaged portion.

9. The LCD device according to claim 6, the male button is fixed on the surface of the display panel by glue.

10. An LCD device, comprising:
a display panel having four sides;
a frame disposed on a surface of the display panel;
a plurality of fasteners disposed between the frame and the display panel, and positioned at three sides among the four sides of the display panel, each of the fasteners comprising a male button and a female button, the male button fixed on the surface of the display panel facing the frame, the female button disposed on a surface of the frame facing the display panel, wherein the male button and female button are fitted together; and
an L-shaped component disposed on one side without the fasteners among the four sides of the display panel, and utilized to abut against the frame and the side without the fasteners among the four sides of the display panel.

11. The LCD device according to claim 10, wherein the male button has a neck portion and a ringlike engaged portion; the female button has a fastening hole matching the male button, the fastening hole consisting of a big hole and a small hole connected to the big hole, wherein the ringlike engaged portion can enter the fastening hole via the big hole and move towards the small hole so that the neck portion is limited within the small hole.

12. The LCD device according to claim 11, wherein the small hole is slightly larger than the neck portion of the male button and smaller than the ringlike engaged portion.

13. The LCD device according to claim 11, wherein the three sides of the display panel on which the fasteners are disposed are a left side, a right side, and a top side; the L-shaped component is disposed on a bottom side of the display panel.

14. The LCD device according to claim 13, wherein the small hole is positioned at an upper side of the big hole in the female button of each of the fasteners.

15. The LCD device according to claim 14, wherein the L-shaped component abuts against the bottom side of the display panel upwards, so that the neck portion of each male button is fixed within the small hole of each fastening hole.
